(19) United States
(12) Patent Application Publication
(10) Pub. No.: US 2007/0015449 A1
(43) Pub. Date: Jan. 18, 2007

(54) EXHAUST HOOD ENHANCED BY CONFIGURATION OF FLOW JETS

(75) Inventor: Andrey Livchak, Bowling Green, KY (US)

Correspondence Address: PROSKAUER ROSE LLP;PATENT DEPARTMENT, 1585 BROADWAY, NEW YORK, NY, 10036-8299, US

(73) Assignee: HALTON COMPANY, Scottsville, KY (US)

(21) Appl. No.: 11/307,439

(22) Filed: Feb. 7, 2006

(30) Foreign Application Priority Data
Aug. 13, 2003 (WO) PCT/US03/25515

(51) Int. Cl. B08B 15/02

(52) U.S. Cl. 454/61

(57) ABSTRACT

An exhaust hood captures and contains a thermal plume with a minimum of exhaust air using low velocity exhaust with confinement jets and stabilization jets in various configurations that help to induce fumes into the hood and protect the thermal plug flow from room transients.

### CROSS REFERENCE TO RELATED APPLICATIONS

This application claims benefit of priority PCTUS03/25515 filed Aug. 16, 2003.

### FIELD OF THE INVENTION

The present invention relates to exhaust hoods with air curtains.

### DESCRIPTION OF THE RELATED ART

Exhaust hoods for ventilation of pollutants from kitchen appliances, such as ranges, promote capture and containment by providing a buffer zone above the pollutant source where buoyancy-driven momentum transients can be dissipated before pollutants are extracted. By managing transients in this way, the effective capture zone of an exhaust supply can be increased.

Basic exhaust hoods use an exhaust blower to create a negative pressure zone to draw effluent-laden air directly away from the pollutant source. In kitchen hoods, the exhaust blower generally draws pollutants, including room-air, through a filter and out of the kitchen through a duct system. An exhaust blower, e. g., a variable speed fan, contained within the exhaust hood is used to remove the effluent from the room and is typically positioned on the suction side of a filter disposed between the pollutant source and the blower.

Depending on the rate by which the effluent is created and the buildup of effluent near the pollutant source, the speed of exhaust blower may be manually set to minimize the flow rate at the lowest point which assures full capture and containment.

Referring to FIG. 1, a typical prior art exhaust hood 90 is located over a range 15. The exhaust hood 90 has a recess 55 with at least one vent 65 (covered by a filter 60) and an exhaust duct 30 leading to an exhaust system (not shown) that draws off contaminated air 45.

The vent 65 is an opening in a barrier 35 defining a plenum 37. The exhaust system usually consists of external ductwork and one or more fans that pull air and contaminants out of a building and discharge them to a treatment facility or simply into the atmosphere. The recess 55 of the exhaust hood 90 plays an important role in capturing the contaminant because heat, as well as particulate and vapor contamination, is usually produced by the contaminant-producing processes. The heat causes its own thermal convection-driven flow or plume 10 which must be captured by the hood within its recess 55 while the contaminant is steadily drawn out of the hood. The recess creates a buffer zone to help insure that transient convection plumes do not escape the steady exhaust flow through the vent. The convection-driven flow or plume 10 may form a vortical flow pattern 20 in a wall-mounted hood as illustrated due to the Coanda effect, which causes the thermal plume 10 to cling to the back wall creating an asymmetry in the flow pattern. The exhaust rate in all practical applications is such that room air 5 is drawn off along with the contaminants.

In reality, the vortical flow pattern 20 is not well defined. The low flow velocities and fluid strain scatter the mean flow energy into a distribution of turbulent eddies. These create flow transients 76 which may escape the mean flow 77 moving from the conditioned space into the suction field of the hood. In other words, the flow 77 is turbulent and although the mean flow moves as shown by the arrow at 77, transient currents in the turbulent flow result in gas and air in the exhaust flow being mixed with the ambient. Such transients are amplified by spikes in heat output and gas volume such as caused by surges in steam generation or heat output. The problem is one of a combination of overpowering the strong buoyancy-driven flow using a high exhaust and buffering the flow so that a more moderate exhaust can handle the surges in load.

But basic hoods and exhaust systems are limited in their abilities to buffer flow. The exhaust rate required to achieve full capture and containment is governed by the highest transient load pulses that occur.

This requires the exhaust rate to be higher than the average volume of effluent (which is inevitably mixed with entrained air). Such transients can be caused by gusts in the surrounding space and/or turbulence caused by the plug flow (the warm plume of effluent rising due to buoyancy). Thus, for full capture and containment, the effluent must be removed through the exhaust blower operating at a high enough speed to capture all transients, including the rare pulses in exhaust load.

The brute force approach of increasing the exhaust rate results in energy loss, since conditioned air must be drawn out of the space in which the exhaust hood is located. Further, high volume operation increases the cost of operating the exhaust blower and raises the noise level of the ventilation system. Thus, there is a perennial need for ways of improving the ability of exhaust hoods to minimize entrained conditioned air and to buffer transient fluctuations in exhaust load.

One technique described in the prior art involves the use of a source of “makeup” air. The make-up is unconditioned air that is propelled toward the exhaust blower. This “short circuit” system involves an output blower that supplies and directs one, or a combination of, conditioned and unconditioned air toward the exhaust hood and blower assembly. The addition of an output blower creates a venturi effect above the cooking surface, which forces the effluent, heat, grease, and other particles toward the exhaust hood.

Such “short circuit” systems have not proven to reduce the volume of conditioned air needed to ensure full capture and containment under a given load condition. In reality, a short circuit system may actually increase the amount of conditioned air that is exhausted. To operate effectively, the exhaust blower must operate at a higher speed due to the need to remove not only the effluent-laden air but also to remove the make-up air. Make-up air may also increase turbulence in the vicinity of the effluent source, which may increase the volume of conditioned air that is entrained in the effluent, thereby increasing the amount of exhaust required.

Another solution in the prior art is described in U.S. Pat. No. 4,475,534 titled “Ventilating System for Kitchen. ” In this patent, the inventor describes an air outlet in the front end of the hood that discharges a relatively low velocity stream of air downwardly.

According to the description, the relatively low velocity air stream forms a curtain of air to prevent conditioned air from being drawn into the hood. In the invention, the air outlet in the front end of the hood assists with separating a portion of the conditioned air away from the hood. Other sources of air directed towards the hood create a venturi effect, as described in the short circuit systems above. As diagramed in the figures of the patent, the exhaust blower must “suck up” air from numerous air sources, as well as the effluent-laden air.

Also the use of a relatively low velocity air stream necessitates a larger volume of airflow from the air outlet to overcome the viscous effects that the surrounding air will have on the flow.

In U.S. Pat. No. 4,346,692 titled “Make-Up Air Device for Range Hood,” the inventor describes a typical short circuit system that relies on a venturi effect to remove a substantial portion of the effluent. The patent also illustrates the use of diverter vanes or louvers to direct the air source in a downwardly direction. Besides the problems associated with such short circuit systems described above, the invention also utilizes vanes to direct the airflow of the output blower. The use of vanes with relatively large openings, through which the air is propelled, requires a relatively large air volume flow to create a substantial air velocity output. This large, air volume flow must be sucked up by the exhaust blower, which increases the rate by which conditioned air leaves the room. The large, air volume flow also creates large-scale turbulence, which can increase the rate by which the effluent disperses to other parts of the room.

Aside from performance, there are also issues of practicality in the provision of air curtains to enhance capture and containment. Freestanding canopy hoods covering island sources present problems due to cross- drafts and provision of ductwork.

### SUMMARY OF THE INVENTION

Effluent is extracted from pollutant sources in a conditioned space, such as a kitchen, by a hood whose effective capture and containment capability is enhanced by the use of air curtain jets positioned around the perimeter of the hood and directed upwardly or downwardly. The particular range of velocities, positioning, and direction of the jets in combination with a shape of the hood recess, may be such as to create an enhanced buffer zone below the hood or may also be such as to induce a turbulent thermal plume with high concentration of pollutants into the hood and thereby minimize escape. The latter effects may reduce the volume flow of air required to ensure full capture and containment.

Downward-flowing air curtains may originate from a perimeter of a hood while upward-flowing air curtains may originate from discharges arranged around the source.

Where multiple source devices, such as ranges, exist, discharges may be arranged around the perimeter of each source device. A single canopy may cover the multiple sources such that some of the discharges may be arranged toward the center of the hood while others are arranged near the perimeter of the hood. The central location of some discharges may allow for enhanced vacuum effect caused by entrainment of air trapped within the canopy and setting up vortical flows within the canopy that capture and control thermal plumes rising at a velocity that is higher than the mean exhaust velocity over the face area of the hood open end.

By positioning a series of jets on, or near, the exhaust hood, the air jets confine the entry of conditioned air into the exhaust stream to an effective aperture defined by the terminus of the air curtain.

Preferably, the curtain (s) flow (s) along a tangent of the vortical flow pattern, part of which is within the canopy recess and part of which is below it, to confine and augment the vortex. The large volume defined by the/canopy interior, extended by the jets, creates a large buffer zone to smooth out transients in plug flow. The enhanced capture efficiency permits the exhaust blower to operate at a slower speed while enforcing full capture and containment. This in turn minimizes the amount of conditioned air that must be extracted with a concomitant reduction in energy loss.

One aspect of the invention involves the shape of the exhaust hood. The hood is shaped such that the plug flow due to heated, effluent-laden air and the positioning and direction of the air jets creates a vortex under the hood. The hood is preferably shaped so that its lower surface-the outer surface closest to the cooking surface-is smooth and rounded, thereby reducing the number and size of the dead air pockets that reside under the hood. Corners can create dead pockets of air, which affect the direction and speed of the airflow. The bulk flow due to buoyancy of the heated pollutant stream creates a first airflow in an upward direction. The air jets create a second airflow offset from the first airflow. Between these two patterns, a vortical flow arises which is sustained by them. This stable vortical flow minimizes the strain of the mean flow of the curtain, which reduces entrainment of room air into the curtain. In addition, the curtain creates a bottleneck reducing the effective aperture for the flow of conditioned air into the exhaust stream thereby causing it to have a higher mean velocity, which in turn enhances the capture effect, assuming the transients do not increase concomitantly.

The embodiments disclosed also include configurations with upwardly directed flows. This may be particularly suitable for use with canopy hoods.

Discharges may be located around the perimeter of the fume source and directed into the canopy forming a curtain. Alternatively, or in addition, jets may be generated between fume sources covered by a common canopy. Such upwardly-directed jets, located in the middle of a canopy may be used in cooperation with downwardly-directed jets around the perimeter to enhance the vortical flow pattern. That is, the jets on the perimeter may be in opposite direction and on opposite sides of the vortex creating two tangential flows that augment the vortex. In another alternative, only one upwardly directed jet is generated on one side of a canopy configuration. The upward flow induces flow from surrounding volumes of gas and air enhancing the capture effect. Preferably, the flow is arranged so that it augments a vortical flow in a buffer zone of the hood.

Another aspect of the invention involves the configuration of the airjets. The ideal configuration is dependent upon a number of factors, including the size of the cooking assembly, the cooking environment, and certain user preferences. Although the dependency on the numerous factors may change the ideal configuration from one environment to the next, following certain principles, which are described below, may increase the efficiency of the system.

Multiple jets that have nozzles with smaller diameters and that propel air at a higher velocity are generally more effective than a single jet with one long and narrow nozzle or even multiple jets with much larger nozzles. The effectiveness of the airjets depends, in large part, on its output velocity. Air jets with larger nozzles must discharge air at a faster rate to achieve a comparable output velocity. Jets with lower output velocities create an air flow that dissipates more quickly due to loss of momentum to viscosity and may have a throw that is only a short distance from the nozzle.

On the other hand, smaller nozzles generally produce much smaller scale turbulence and tend to disturb the thermal flow created by the cooking surface to a lesser degree than larger scale turbulence. Smaller nozzles also require less air. Because of the lesser amount of air that is needed for the air jets, the air jets can propel conditioned air, unconditioned air, or a mixture of the two. The use of conditioned air is preferable and eliminates the need for the air jets to have access to an outside source of air. The use of conditioned air also provides additional benefits. For example, on a cold day, the use of unconditioned air may cause discomfort to the chef who is working under the cold air jets or may subject the cooking food to cold, untreated and particle- carrying air. The use of cold, unconditioned air may also affect the thermal flow of the effluent-laden air by creating or highlighting an undesired air flow pattern due to the temperature differences between the air jet air and the effluent-laden air.

The invention will be described in connection with certain preferred embodiments, with reference to the following illustrative figures so that it may be more fully understood.

With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention.

In this regard, no attempt is made to show structural details of the invention in more detail that is necessary for a fundamental understanding of the invention, the description taken with the drawings making apparent to those skilled in the art how the several forms of the invention may be embodied in practice.

### BRIEF DESCRIPTION OF THE DRAWINGS

FIG. 1 is a cross-sectional representation of a canopy style kitchen exhaust hood according to the prior art.

FIG. 2 is a cross-sectional representation of a wall-canopy style kitchen exhaust hood according to an embodiment of the invention.

FIG. 3A is a cross-sectional representation of a back-shelf style kitchen exhaust hood according to another embodiment of the invention.

FIG. 3B illustrates a hood from a perspective view.

FIG. 4 is a cross-sectional representation of an island-canopy style kitchen exhaust hood according to another embodiment of the invention.

FIG. 5A is an isometric view of a panel of duct segment with a series of jets to form either upwardly or downwardly-directed jets according to various embodiments of inventions disclosed herein.

FIGS. 5B and 5C are figurative illustrations (5B in elevation-view) and 5C being in perspective view) of a cooking appliance for illustrating various configurations for forming corner augmentation-jets and locating exhaust intakes within a hood for augmenting capture of fumes near corners of a hood where the long perimeter and remoteness of exhaust intakes near corners (corner effect) make it easier for fumes to escape.

FIG. 6 is a cross-sectional representation of a wall-canopy style hood with vertical and horizontal jets to augment capture and containment according to still another embodiment of the invention.

FIGS. 7-9 are plan views of various jet patterns according to embodiments of the invention.

FIGS. 10A and 10B illustrate jets arranged to blow upwardly into a hood.

FIGS. 11A and 11B illustrate jets arranged to blow upwardly into a hood.

FIGS. 12A and 12B illustrate upward flow jets and a hood configuration.

FIGS. 13 through 15 illustrate variations on upwardly flowing jets according to various embodiments..

FIGS. 16 through 21 illustrate variations on horizontal jets according to various embodiments.

FIGS. 22 through 25B illustrate mechanical features of upwardly flowing jet configurations in several embodiments.

### DETAILED DESCRIPTION OF THE DRAWINGS

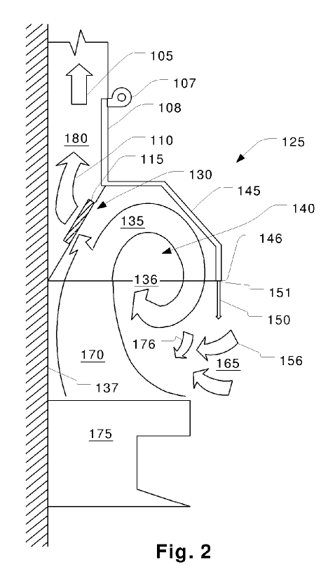

Referring now to FIG. 2, effluent produced when food is cooked on a grill 175 creates a plume 170 that rises into a canopy recess 140. The recess 140 may be shaped to have a faceted or curved interior face to reduce resistance to a vortical flow 135. Grease or other particulates may be removed by an air filter 115, located in an exhaust vent 130 inside the canopy recess 140.

In the current embodiment, a planar curtain jet 150 is generated by injecting room air downwardly from a forward edge 146 of the canopy 145 through apertures (not visible) in a horizontal face of the forward edge 146.

The forward edge 146 jet 150 may be fed from a duct 108 integral to the canopy 145. Individual jets 151 are directed substantially vertically downward and spaced apart such that they coalesce into the planar curtain jet 150 a short distance from the nozzles from which they originate. The source of the conditioned air may be conditioned space or another source such as make-up air or a combination of make-up and conditioned air.

Although not illustrated, the exhaust assembly 10 can also be designed with the curtain jet 150 directed downwardly but in a direction that is tilted toward a space 136 between the jet 150 and a back wall 137. The various individual jets 151 may be re-configurable to point in varying directions to permit their combined effect to be optimized.

During operation, pollutants are carried upwardly by buoyancy forming a flow 170 that attaches (due to the Coanda effect) to a rear bounding wall 137 due to the no flow boundary condition. The flow 170 has more energy than that of a mean mass flow propelled by the exhaust suction, so the extra energy is dissipated in the form of turbulent eddies whose energy is ultimately lost to viscous friction. Large eddies give energy to successively small eddies in a cascade in which the largest-scale, and most energetic, is the vortical flow 135. Preferably, the turbulent eddies remain in the canopy recess 140 or are drawn out into the exhaust duct 180 while their energy dissipates rather than escaping, with suspended contaminants, into the surrounding space.

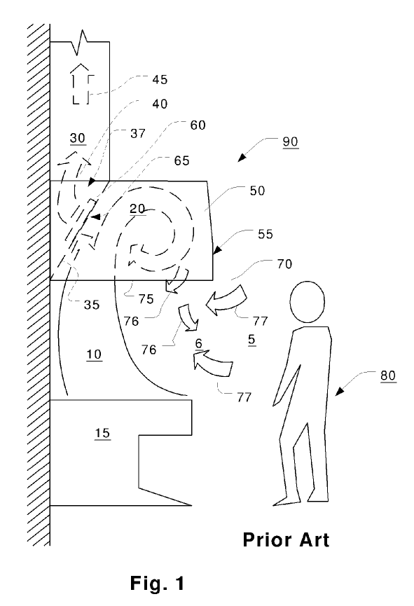

In prior art systems, the vortex 135 turbulence results in transient and repeated reverse flows 76 (See FIG. 1) that cause the escape of effluent unless their energy is low relative to the exhaust flow rate. In the embodiment of FIG. 2, the curtain jet 150 forces the air being drawn from the room 156 into a narrower channel 165 than the corresponding channel 6 of the prior art system.

Thus, the mean velocity of the flow from the room into the exhaust stream is higher relative to the transient reverse flows 176.

An additional advantageous effect is associated with the curtain jet 150 and hood recess 140 combination. The curtain jet 150 helps to define a larger effective buffer zone 136 than the canopy recess 140 alone. Because the vortex 135 is larger, the fluid strain rate within it is lower so less turbulent energy is generated. The strain rate is further reduced by the moving boundary condition along the inside surface of the jet 150.

Preferably, the jet 150 is designed to propel air at such velocity and width that the downwardly directed air flow dissipates before getting too close to the range 175. In other words, the jet's “throw” should not be such that the jet reaches the plume 170. Otherwise, the plume 170 will be disrupted causing turbulent eddies and possible escape of pollutants.

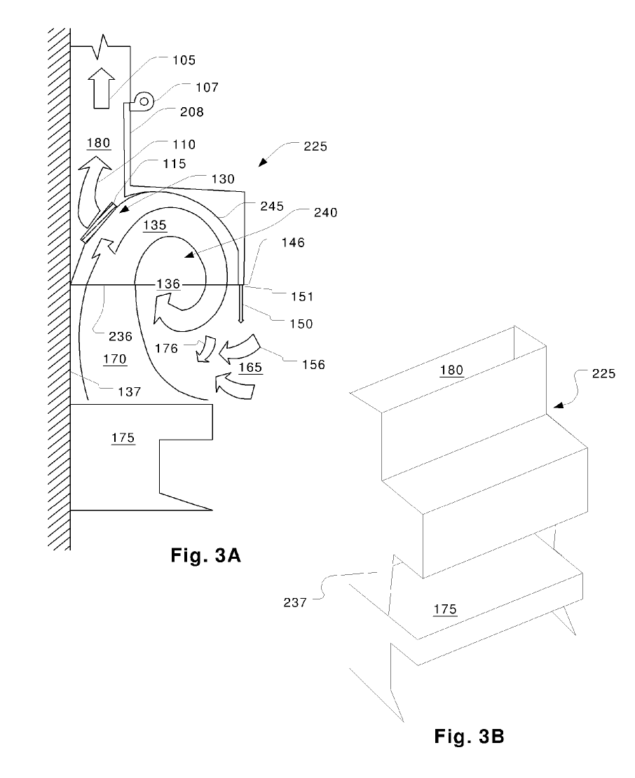

Referring now to FIG. 3, in an alternative embodiment, an exhaust hood 225 is shaped such that the walls of its recess 240 surface form a smooth curve helping to reduce resistance to the 135 vortex. To enhance and prevent leakage from the sides, panels 236 may be located on the sides, thereby preventing effluent from escaping through the ends where the panels 236 are present. The panels may be extended to the range 175 as illustrated at 237. Alternatively, the curtain jets 150 may extend around the entire exposed perimeter of the hood 240.

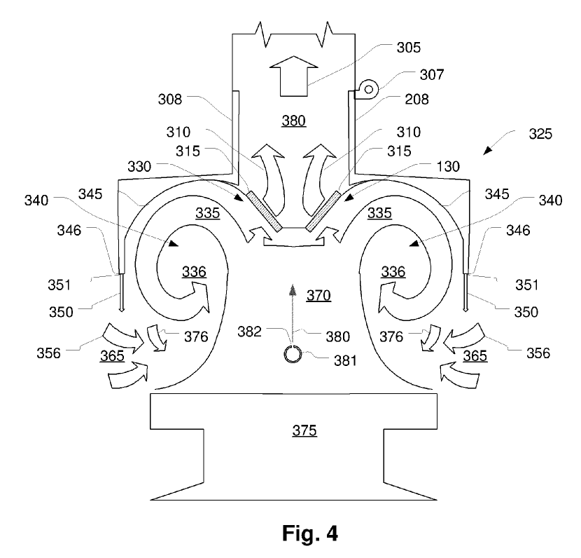

Referring now to FIG. 4, an island pollutant source such as a grill 375 is open on four sides. Curtain jets 350 are generated around an entire perimeter of a canopy-style exhaust hood 325. The filters 315 may be arranged in a pyramidal structure as illustrated. The depth (dimension into the plane of the figure) of the hood 325 is arbitrary. In the illustrated configuration, there is no back surface for a thermal plume 370 to attach to, as in the preceding backshelf hood configurations, so a free-standing plume 370 is formed. Vortices 335 may form in a manner similar to that discussed above with respect to the wall-mounted canopy hoods 125 and 225.

In an alternative embodiment, a header 381 is provided with a slot 382 or series of holes (along a line heading into the plane of the figure) to create a planar jet 380 that induces flow into the hood. The header 381 may be used in combination with other features described herein or as an alternative.

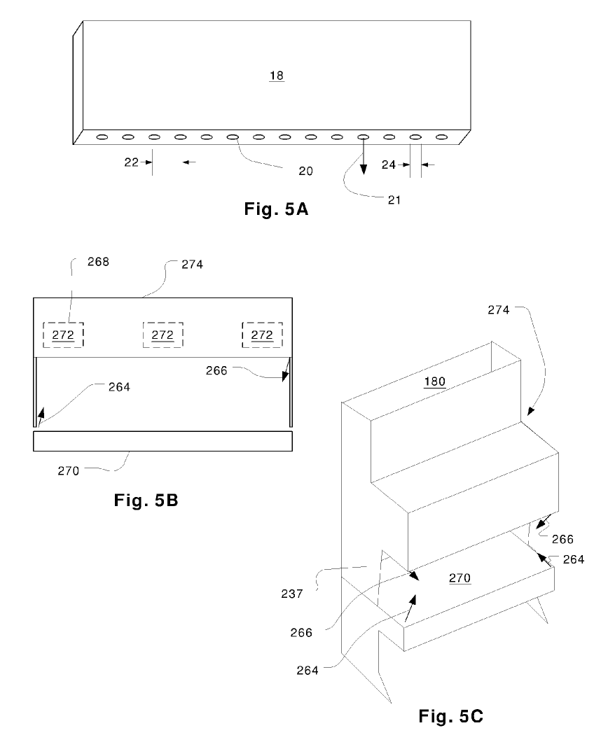

Referring now to FIG. 5A, an arrangement of air nozzles 20, separated by a distance 22 and positioned to form a substantially straight line across the front of a duct attached to an exhaust hood or top of a cooking appliance 18 to form upwardly directed or downwardly directed jets, one of which is shown at 21. The nozzles 20 are spaced apart from each other such that the individual jets (e.g., 21) combine into a curtain jet such as 150 (FIG. 3A) and 350 (FIG. 4) in previously illustrated embodiments and other embodiments in drawings discussed below. This occurs because the jets expand due to air entrainment and coalesce a short distance from the nozzles 20.

In a preferred embodiment, each of the nozzles 20 has an orifice diameter 24 of approximately 6.5 mm, and combined, the jets 20 have an initial velocity of approximately 9 ft3/min/linear ft. (The “linear ft.” length refers to the length of the edge along which the jet generated.) Preferably, the range is between 3 and 15 ft 3/min/linear ft. The velocity of the jet, of course, diminishes with distance from the nozzles 20. The initial velocity and jet size should be such that the jet velocity is close to zero by the time it reaches the plume 170/370. Alternatively, the jet 150/150 should be directed in such a direction that its effect is not disruptive to the plume, for example, by directing the jet outwardly away from the hood recess 140/340. In fact, in an island application, because of cross-drafts in the conditioned space, there may be a need to form a more robust curtain jet 350 to protect the plume 370. In such a case, the overhang (the position of the perimeter of the hood, in a horizontal dimension, from the outermost edge of the pollutant source 375) and direction of the jet 350 may be made such that there is little or no disruption of the plume due to the jet 350. Note that the nozzles 20 may simply be perforations in a plenum defined by the front section 18 of the exhaust hood.

Alternatively, they may be nozzle sections with a varying internal cross section that minimizes expansion on exit.

The nozzles may contain flow conditioners such as settling screens and/or or flow straighteners.

Although the nozzle configuration was discussed above in connection with downwardly directed curtain jets, the same discussion applies to upwardly directed jets discussed with respect to further embodiments described below.

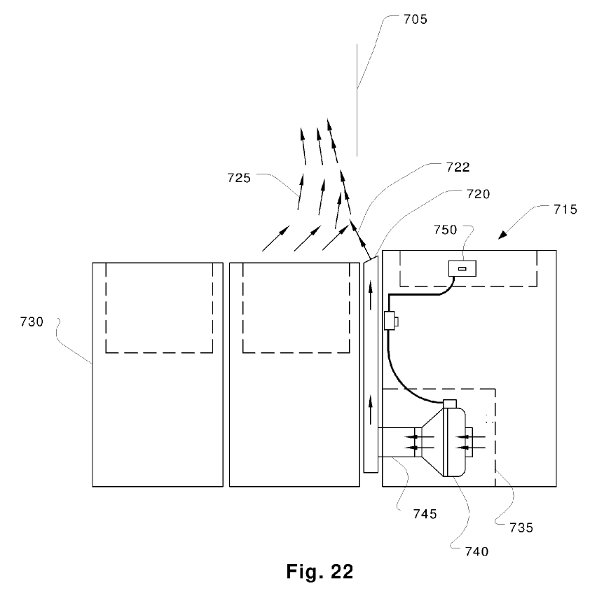

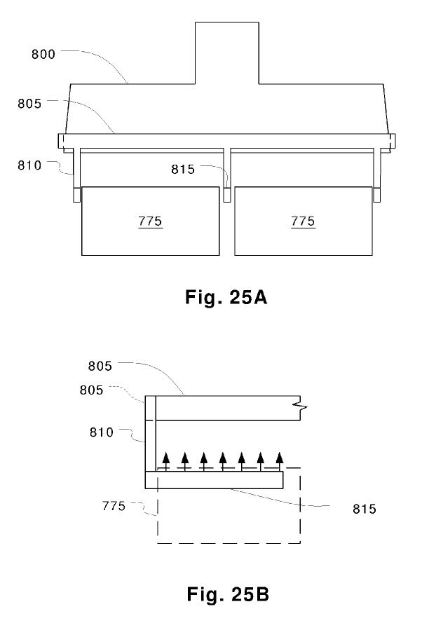

Referring to FIG. 5B, a corner jet 264 originating near a perimeter of a cooking appliance, a top of which is shown at 270, may help to augment capture of effluent at the corners where hoods are particularly vulnerable to spill effects due to a relatively low ratio of suction head from normally medially-located intakes within the hoods to perimeter length. The corner jet 264 may be generated by any of a number of ducting strategies described in embodiments of FIGS. 22-25B. The jet 264 may be located at all corners of an appliance located under a canopy style hood or at two corners of a backshelf hood. An alternative location of a corner jet is the downward and inwardly directed jet at 266. This location and direction may help to induce fumes near the edge of the hood back into a main flow being exhausted.

A third mechanism for ameliorating the corner effect identified above is to space internal intakes 272 in such positions that they favor the ends of the hood 274 in ( terms of suction head.

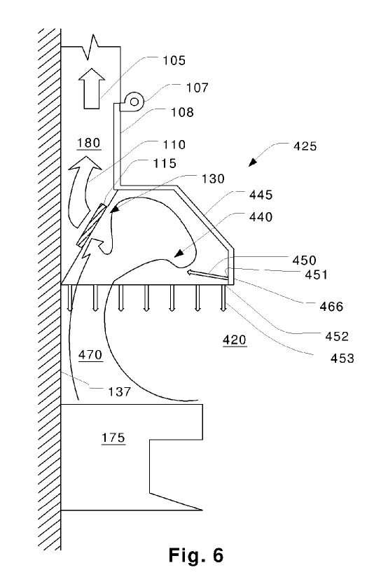

Referring now to FIG. 6 as in the previous embodiments, a source of pollutants, such as a grill 175 generates a hot effluent plume 175. A nozzle arrangement producing a prior art type of capture augmentation jet 451 is located along the forward inside edge 466 of a canopy hood 425. The nozzles are arranged to form a planar jet as discussed with respect to the curtain jets 150/350 of previous embodiments. This horizontal jet 450 pushes the plume 470 toward the exhaust vent 130. It also creates a negative pressure field around the forward edge 466 of the hood 425, which helps containment. The prior art configuration, however, suffers from spillage of the effluent plume 470 from the sides of a canopy 425.

According to the invention, a side curtain jet 452 may be used in concert with the capture augmentation jet 451 to mitigate the spillage problem. The side curtain jet works in a manner as described above with respect to the earlier embodiments. That is, it forces exhausted air from the surrounding conditioned space to flow through a narrower effective aperture thereby providing greater capacity to overcome fluctuating currents with a lower volume exhaust rate than would otherwise be required. In an alternative embodiment, the side curtain jet is tilted inwardly to push the plume toward the center of the canopy recess 440.

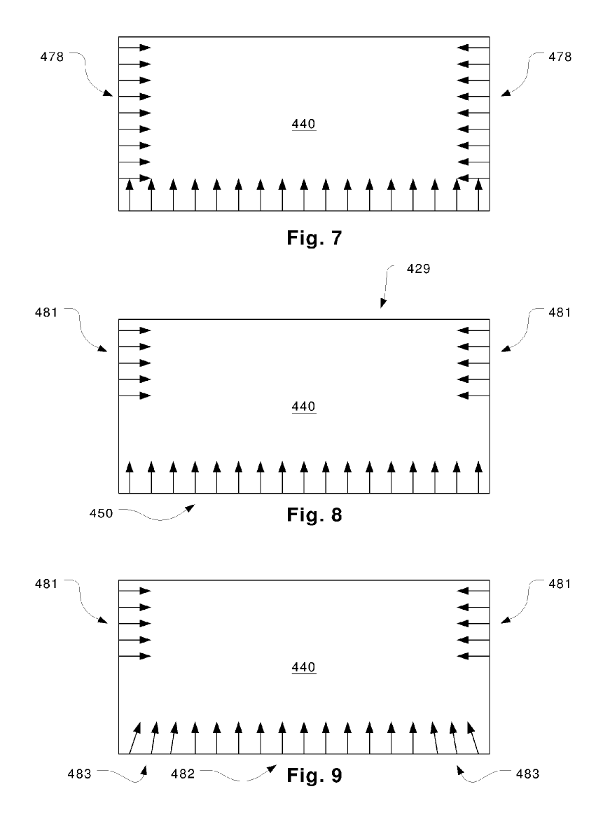

Referring to FIG. 7 in another alternative embodiment, a horizontal capture augmentation jet 478 is generated around the entire perimeter of the hood 429 rather than forming a vertical curtain jet 453.

Referring to FIG. 8 in still another embodiment, the capture augmentation jet 481 extends only partly along the sides with a full capture augmentation jet 450 across the forward edge of the hood. Referring to FIG. 9 in yet another embodiment the forward edge capture jet 482 is formed by individual jets. The ones at the corners 483 are directly toward the center as indicated. This helps to prevent side spillage.

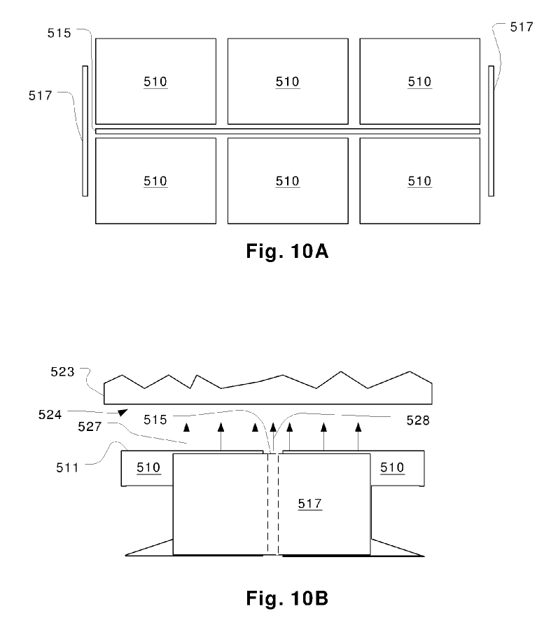

Referring now to FIGS. 10A and 10B, a number of cooking appliances 510 are arranged rectilinearly under a canopy hood 523 (not shown in FIG. 10A). Discharges 515 and 517 are arranged to generate jets directed upwardly into the opening of the hood 523. The centrally located discharge 515 directs a jet 528 directly into the center of the hood 523 while the end discharges 517 located at the end of the hood 523 direct a jet 527 inwardly toward the opening 524 of the hood 523 at a slight angle from vertical. The jet 528 from the centrally located discharge 515 creates a negative pressure near the top surface of the cooking appliances 510 that draws into itself, and directs any fumes flowing near the tops 511 of the cooking appliances 510, into the hood 523. The jets 527 from the discharges at the ends of the hood 523 perform a similar function and also help to form a curtain to protect against room air currents carrying a fume plume (not shown) away from the hood 523.

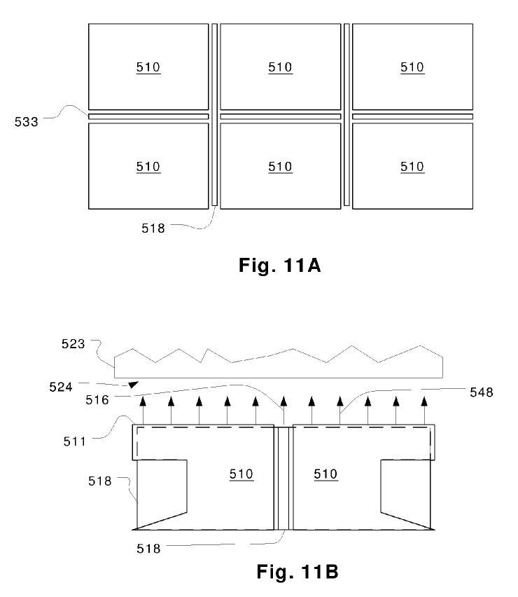

Referring to FIGS. 11A and 11B, crossing sets of centrally located discharges 533 and 518 direct jets 516 and 548 upwardly into the hood 523 opening 524. The effect is similar to that described for the embodiment of FIGS. 10A and 10B except that instead of locating one set of discharges at ends of the set of cooking appliances 510, as at 517 in FIGS. 10A and 10B, discharges 518 are located centrally. All the discharges 533 and 518 help to prevent large scale mixing of fumes with room air by acting as curtains against cross-drafts and by creating a negative pressure by means of jets that direct local flows near the tops 511 of the cooking appliances 510 upwardly into the hood 523.

Note that although in them embodiments of FIGS. 10A, 10B, 11A, and 11B size cooking appliances are shown protected by a single canopy hood, features of the embodiments are applicable to any number of cooking' sources, exhaust hoods, and exhaust styles. In addition, the discharges 533 and 518 could be discontinuous arrays of discharges as well as continuous discharges as illustrated. In addition, the two could be merged into a single structure.

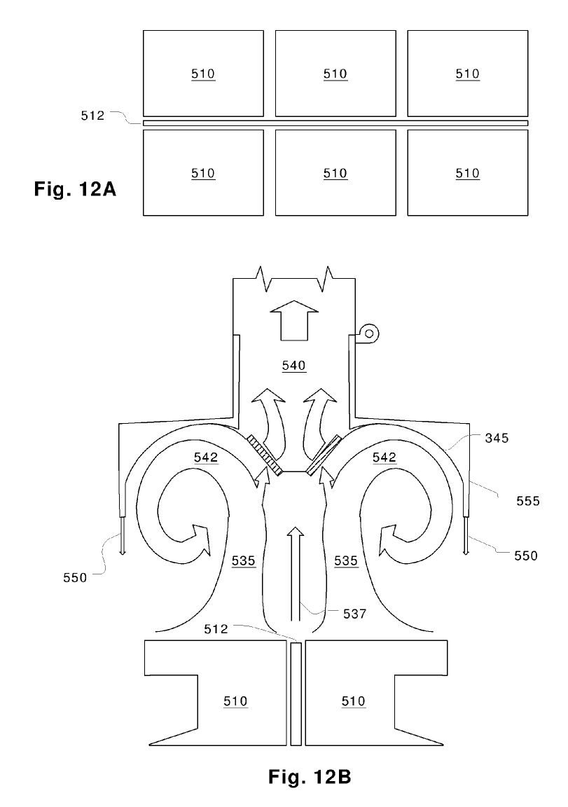

Referring to FIGS. 12A and 12B, a central discharge 512 is located between sets of cooking appliances 510 and configured to direct as jet 537 centrally into a hood 555. In the embodiment, the hood 555 may be configured in a manner similar to that of FIG. 4. The hood 555 may or may not have downwardly directed curtain jets 550.

The effect of the jet 537 created by the central discharge 512 is similar to that discussed in the previous two embodiments. Particularly in the present embodiment, however, a vortex pattern 542 is augmented by the position and arrangement of the jet 537 produced by the central discharge 512 since it is tangential to it.

If downwardly directed curtain jets 550 are also provided, the upward jet 537 and downward jet 550 are both tangential to the vortex pattern 542 and therefore augment the pattern in concert.

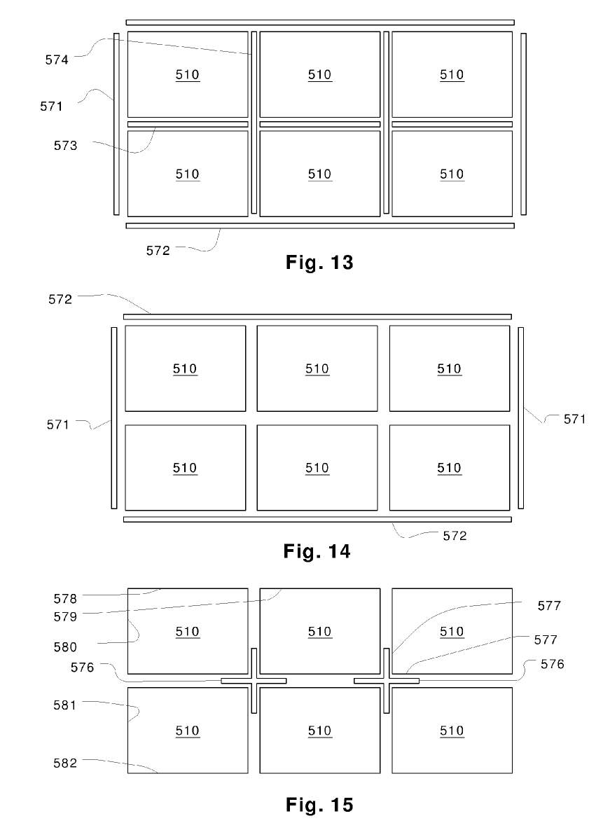

Referring to FIGS. 13, 14, and 15, several arrangements of discharges for creating upwardly-directed jets are shown. In FIG. 13, discharges 573 and 574 are directed into the center of a hood (not illustrated, but similar to previous embodiments). In addition, the embodiment of FIG. 13 has discharges 571 and 572, which surround the cooking appliances 510 forming upwardly-directed jets that act as air curtain. Such curtain jets may be directed downwardly as well as described with respect to the embodiment of FIGS. 12A and 12B.

Referring to FIG. 14, perimeter discharges may be used alone to act as curtains to protect a thermal plume from cross-drafts. Again, if upwardly directed, the jets may help to induce fumes toward the hood inlet, particularly if directed slightly inwardly from vertical.

Referring now to FIG. 15, upwardly-directed jets issue from centrally-located discharges 576. The latter, preferably but not necessarily, extend along a portion of an internal perimeter 577 of the cooking appliances 510 so that a local low pressure zone is created to induce fumes into the upwardly-directed jets. The effect of these jets is to induce a low pressure zone that draws fumes toward the center of a hood (not shown) overlying the cooking appliances 510 helping to ensure capture and containment by keeping fumes away from an external perimeter of the cooking appliances (indicated by examples at 578-582). The discharges 576 may also be shaped as round jets with virtually zero extension along the internal perimeters 577 of the cooking appliances 510.

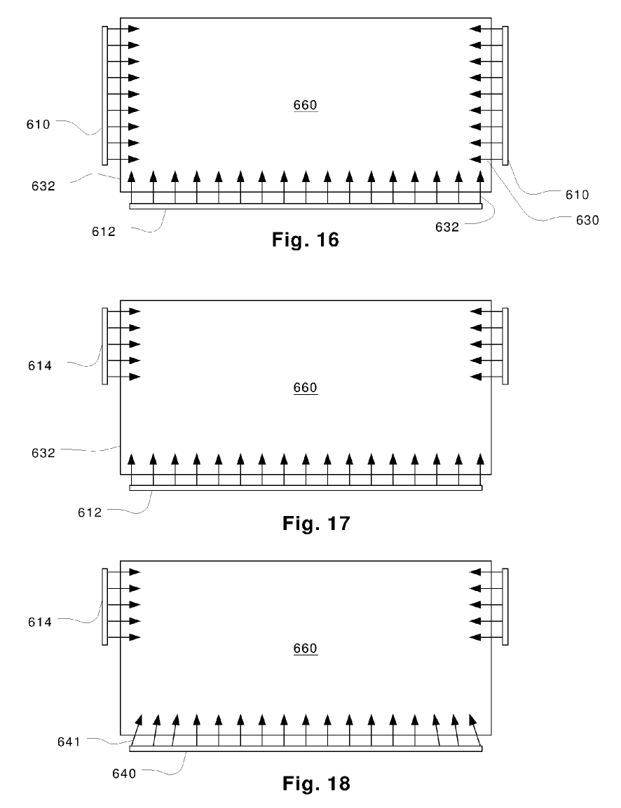

Referring to FIGS. 16, 17, and 18, one or more cooking appliances 660 are surrounded by discharges 610 and 612 at their perimeters. The cooking appliances 660 shown have one side walled off with a hood overhead (not shown) as in a backshelf-style hood. The arrows e. g., 630 and 632, indicate upwardly-directed jets from respective discharges 610 and 612. The figure is a plan projection, so only the non-vertical component of the jet is indicated by the length of the arrows 630 and 632. As can be seen, the jets are directed inwardly to the extent necessary to insure that they direct fumes toward the inside of the hood. For a hood that overhangs the cooking appliance (s) 660 substantially, the jets may be vertical or even partly outwardly directed so long as induced flow is directed into the hood opening. The configuration of FIG. 16 skirts the entire perimeter.

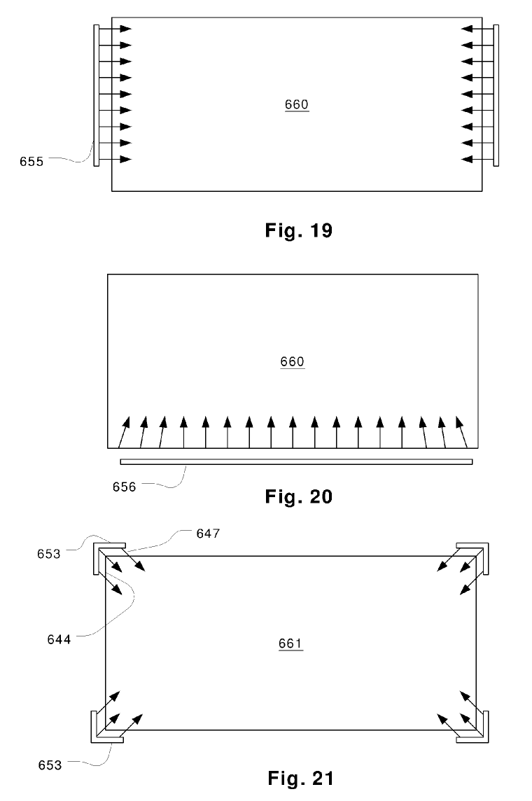

The configuration of FIG. 17, provides a shorter discharge 614 relative to the perimeter 632. The configuration of FIG. 18 has a discharge 640 that directs jets that are tilted slightly toward the center of the hood from a plan perspective. Referring to FIGS. 19 and 20, side and front discharges 655 and 656 respectively may be used independently with similar effect as in the embodiment of FIG. 18.

Referring to FIG. 21, one area that may be problematic is the corner portions 644 of the perimeter of one or more cooking appliances 661 protected by a hood (not shown). The suction head of a hood can diminish due to the larger distance from an internal intake, for example as shown at 130 in FIG. 6, and also due to the larger perimeter from which fumes may escape. The capture of fumes at the corner portions 644 may be augmented by the addition of corner discharges 653. The latter produce upwardly-directed jets with plan-view components as indicated by the arrows 647. Again, the jets may be directed straight up or even outwardly depending on the degree of overhang, but are preferably directed inwardly as indicated. Also, although four protected corners are illustrated in the drawing, the concept applies with equal force to a backshelf hood where only two corners may need such augmentation.

Referring to FIG. 22, a pair of deep-fryers 930 are shown in elevation. Fumes 725 from the deep-fryers 730 are drawn into a hood, a side edge of which is indicated at 705. A dump station 715, used for temporary storage of fried food, is positioned adjacent the deep fryers 730. Between the two, a duct 720 directs a jet 722 upwardly and toward the center of the hood 705. The duct 720 is a flat prismatic shape extending along a line perpendicular to the plane of the page of FIG. 22. Air is blown into the duct 720 by a fan 740 located in a hollow 735 in the dump station 715. An adapter 745 connects the fan 740 with the duct 720. The above is illustrative of one way of providing for discharge such as those shown in previous embodiments.

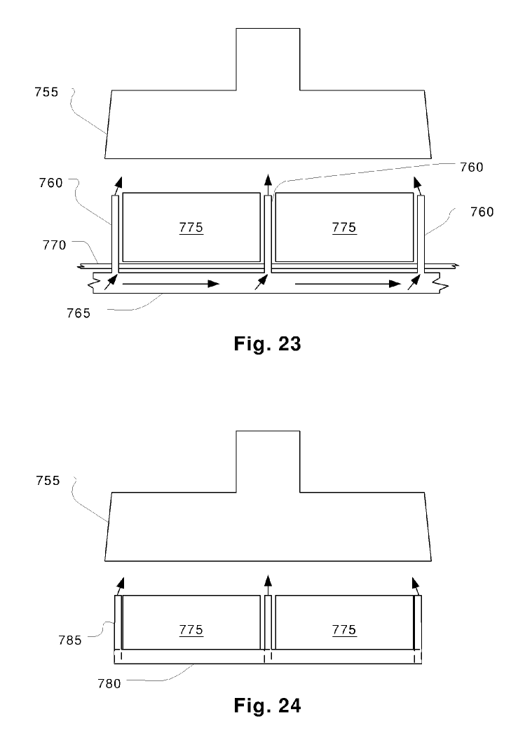

Referring to FIG. 23, the discharges described in any of the foregoing embodiments may be supplied by various means. Shown in elevation view, a hood 755 captures fumes from cooking appliances 775. Discharges are fed by vertical ducting portions 760 that rise from a feed duct 765 located below the level of a floor 770.

Referring to FIG. 24, a feed duct 780 attached to (or optionally internal to the cooking appliances 775, supplies air to vertical ducting portions 785. The feed duct 765 may be fed by a supply through the floor or run down from the ceiling (not shown). Referring to Figs.

25A and 25B, still another means by which the discharges of any of the foregoing embodiments may be supplied is via a supply duct 805 attached to a hood 800. The supply duct 805 supplies multiple legs 810 connected to discharge headers 815. The supply duct 805 may fully or partially surround the hood 800.

It will be evident to those skilled in the art that the invention is not limited to the details of the foregoing illustrative embodiments, and that the present invention may be embodied in other specific forms without departing from the spirit or essential attributes thereof. For, example, while in the embodiments described above, curtain jets were formed using a series of round nozzles, it is clear that it is possible to form curtain jets using a single slot or non-round nozzles. Also, the source of air for the jets may be room air, outdoor air or a combination thereof. The invention is also applicable to any process that forms a thermal plume, not just a kitchen range. Also, the principles may be applied to backshelf hoods, which have no overhang as well as to the canopy style hoods discussed above. Also, we note that although in the above embodiments, the hood and vortex were discussed in terms of a cylindrical vortex, it is possible to apply the same invention to multiple cylindrical vortices joined at an angle at their ends such as to define a single toroidal vortex for an island canopy. The torus thereby formed could also be rectangular for low aspect-ratio island hoods. Still further, in consideration of air curtain principles, it would be possible to direct the curtain jets outwardly while still providing the described benefits. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. An apparatus for augmenting the capture by a fume hood of fumes rising from at least one cooking appliance, comprising: at least one discharge register arranged to generate at least one upwardly-directed jet to induce fumes from said cooking appliance into an exhaust flow of said fume hood; said discharge register being located in a central area under said hood substantially central with respect to a perimeter of said hood, defined with respect to a plan perspective, thereof and such that said at least one jet originates substantially centrally with respect to said perimeter.

2. An apparatus as in claim 1, wherein said at least one appliance is located substantially within said perimeter and said at least one discharge register is surrounded on at least two opposite sides thereof by fume emanating portions of said at least one cooking appliance, whereby fumes rise around said at least one jet.

3. An apparatus as in claim 1, wherein said at least one cooking appliance includes at least two cooking appliances and said at least one discharge register extends along a line between adjacent ones of said at least two cooking appliances.

4. An apparatus as in claim 1, wherein said jet is shaped and located such as to impede an effect of external air currents on a plume rising from said cooking appliance.

5. An apparatus as in claim 1, wherein said at least one jet is a curtain jet.

6. An apparatus as in claim 1, further comprising a fume hood with a duct descending therefrom to a position of said discharge register and configured to feed air to said discharge such that said at least one jet is generated.

7. An apparatus as in claim 1, further comprising: a fume hood; a further discharge register located to direct at least one downward curtain jet adjacent said perimeter such that at least one vortical flow is generated within said fume hood, said downward curtain jet and said upwardly-directed jet being tangent to said at least one vortical flow.

8. An apparatus as in claim 1, wherein said at least one jet is linearly extended along a perimeter of said at least one cooking appliance and is characterized by a flow rate of between 3 and 15 cubic feet per minute per linear foot.

9. An apparatus for augmenting the capture by a fume hood of fumes rising from at least one cooking appliance, comprising: a canopy fume hood configured to be positioned above a fume source; a discharge register directly below said fume hood at a level that is approximately the same as the top of said at least one cooking appliance and arranged to generate at least one upwardly-directed jet into a central portion of said fume hood; at least a portion of said discharge register being located remote from, and fully within a perimeter of said hood.

10. An apparatus as in claim 9, wherein said at least one discharge extends at least partly along a perimeter of said at least one cooking appliance.

11. An apparatus as in claim 9, wherein said at least one jet is directed at least partially toward a center, from plan perspective, of said hood.

12. An apparatus for augmenting the capture of fumes, by a fume hood, in which the fumes rise from at least two cooking appliances under said hood, comprising: at least at one discharge configured to be located between said at least cooking two appliances and to generate at least one jet configured to induce fumes from said at least two cooking appliances into said hood; said at least one discharge being located between at least two of said at least two cooking appliances within an outer perimeter of said fume hood, said outer perimeter being taken with respect to a plan view, and configured such that said at least one jet is directed upwardly.

13. An apparatus as in claim 12, wherein said at least two appliances are located substantially within said perimeter and said at least one discharge register is surrounded on at least two opposite sides thereof by fume emanating portions thereof, whereby fumes rise around said at least one jet and are induced to flow into it.

14. An apparatus as in claim 12, wherein said jet is shaped and located such as to impede an effect of external air currents fumes rising from said at least two cooking appliances.

15. An apparatus as in claim 12, wherein said at least one jet is a curtain jet.

16. An apparatus as in claim 1, further comprising a fume hood with a duct descending therefrom to a position of said discharge register and configured to feed air to said discharge such that said at least one jet is generated.

17. An apparatus as in claim 1, further comprising: a fume hood; a further discharge register located to direct at least one downward curtain jet adjacent said perimeter such that at least one vortical flow is generated within said fume hood, said downward curtain jet and said upwardly-directed jet being tangent to said at least one vortical flow.

18. An apparatus as in claim 1, wherein said at least one jet is linearly extended along a perimeter of said at least one cooking appliance and is characterized by a flow rate of between 3 and 15 cubic feet per minute per linear foot.

19. An apparatus for augmenting the capture by a fume hood of fumes rising from at least one cooking appliance, comprising: at least one discharge arranged to generate at least one jet that is shaped and directed to induce fumes from said cooking appliance into an exhaust flow of said fume hood; said discharge being located in a central area under said hood substantially within a perimeter thereof, said perimeter being defined with respect to a plan said discharge extending at least partly along a perimeter of said at least one cooking appliance.

20. An apparatus as in claim 19, wherein said at least one jet is effective to impede external air currents otherwise tending to disrupt a flow of fumes from said at least one cooking appliance into said hood.

21. An apparatus as in claim 19, wherein said at least one discharge extends along a perimeter of said at least one cooking appliance, said perimeter providing an access to said at least one cooking appliance.

22. An apparatus as in claim 19, wherein said at least one jet is configured to augment a vortex in said hood.
